(19) United States
(12) Patent Application Publication
(10) Pub. No.: US 2015/0263881 A1
(43) Pub. Date: Sep. 17, 2015

(54) Direct internet plug-in without modem

(71) Applicant: Michael Lewis Moravitz, Fairfax, VA (US)

(72) Inventor: Michael Lewis Moravitz, Fairfax, VA (US)

(21) Appl. No.: 13/999,636

(22) Filed: Mar. 11, 2014

(51) Int. Cl. H04L 29/10

(52) U.S. Cl. CPC H04L 29/10

(57) ABSTRACT

New computer system to allow high speed cable or dial-up cable to be plugged into CPU directly to avoid resistance from routers and modems to access or dial-up Internet service from within computer.

Plug high-speed cable or phone line directly into CPU to reduce resistance and increase speed, while establishing account from software loaded onto computer.

Builds on patents for personal computers and Macs, cables and phone lines connecting to internet, and routers and modems; needs software to establish internet connection on computer screen.

Without a modem or router, high-speed, DSL, and dial-up service would be quicker. In other words, the cable or phone line should go directly into the CPU, bypassing the modem or router. There would be less resistance to overcome and less resistance from changes between a modem and router into the CPU. The user might be able to dial-up through the computer terminal, as one does with a user name and pass word to access the internet. All sorts of logistical problems would have to be overcome for each of these internet providers to use this idea, but already, some of this technology exists and needs to be streamlined with computer manufacturers. This could make dial-up more viable, and it can still expand in the United States and internationally. High-speed and DSL could also benefit if the technical details can be worked out. For example, FIOS cable uses the router from DSL, but the cable conceivable should plug in directly into the computer. Satellite providers enter the home or business by a dish and then a cable and perhaps this idea would work for them as well.

1) Builds on patents for CPUs but would be necessary to adapt to bypass routers and modems to dial-up or access Internet from within computing system using installed software.

2) Builds on patents for Internet Portal Software that would need to be modified in order to use passwords or codes to access Internet from what is typed in on computer screen.
